(19) United States
(12) Patent Application Publication
(10) Pub. No.: US 2009/0103445 A1
(43) Pub. Date: Apr. 23, 2009

(54) METHOD AND APPARATUS FOR ENHANCING VARIOUS PDCP AND LAYER 2 OPERATIONS

(75) Inventors: Mohammed Sammour, Montreal (CA); Stephen E. Terry, Northport, NY (US); Peter S. Wang, East Setauket, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/243,283

(22) Filed: Oct. 1, 2008

Related U.S. Application Data
(60) Provisional application No. 60/976,703, filed on Oct. 1, 2007.

(51) Int. Cl. H04J 1/16; H04B 7/00; H04B 1/38; H04M 1/00; H04W 80/00

(52) U.S. Cl. 370/252; 370/310; 455/73; 455/550.1; 370/328

(57) ABSTRACT

Method and apparatus for enhancing interactions between layers in a wireless communications system. A PDCP layer sublayer provides a delivery confirmation service to at least one upper layer above the PDCP layer.

### CROSS REFERENCE TO RELATED APPLICATIONS

This application claims the benefit of U.S. provisional application No. 60/976,703, filed on Oct. 1, 2007, which is incorporated by reference as if fully set forth.

### FIELD OF INVENTION

This invention is related to wireless communications and apparatus.

### BACKGROUND

Conducting wireless communications using equipment that employ defined protocol stacks are known in the art. FIG. 1 shows a conventional user plane protocol stack in a wireless transmit receive unit (WTRU) and a network element (e.g., an evolved Node-B (eNodeB or eNB), in a third generation partnership project (3GPP) long term evolution (LTE) system. The WTRU includes a packet data convergence protocol (PDCP) layer, a radio link control (RLC) layer, a medium access control (MAC) layer and a physical layer. The eNB includes a PDCP layer, an RLC layer, a MAC layer and a physical layer.

FIG. 2 shows a control plane stack in a WTRU and a network element, e.g., an eNB and a mobility management entity (MME), in the 3GPP LTE system. The WTRU includes a non-access stratum (NAS) layer, a radio resource control (RRC) layer, a PDCP layer, an RLC layer, a MAC layer, and a physical layer. The eNB includes an RRC layer, a PDCP layer, an RLC layer, a MAC layer, and a physical layer, and the MME includes an NAS layer.

In the protocol stack for the control-plane, the PDCP layer (terminated in an E-UTRAN Node B (eNB) on the network side) performs ciphering and integrity protection for the control plane (RRC). The RRC layer performs functions such as broadcast, paging, RC connection management, Radio bearer (RB) control, and mobility functions.

The non-access stratum (NAS) control protocol (terminated in mobility management entity (MME) on the network side) performs functions including EPS bearer management, Authentication, LTE_IDLE mobility handling, Paging origination in LTE_IDLE, and Security control.

The main services and functions of the PDCP sublayer include header compression and decompression, using robust header compression (ROHC), and transfer of user data, typically formatting data into packet data units (PDUs) and/or service data units (SDUs). Generally in connection with the transmission of user data, the PDCP layer receives a PDCP SDU from the network layer (e.g., Internet Protocol (IP)) and forwards it to the RLC layer and vice versa. Reordering of the downlink RLC SDUs during inter-eNB mobility, in-sequence delivery of upper layer PDUs at handover (HO) in the uplink (e.g. using fast session setup (FFS)), duplicate detection of lower layer SDUs, and ciphering of user plane data and control plane data (NAS Signalling) are also functions of the PDCP layer.

FIG. 3 shows a depiction of a PDCP PDU structure which includes a PDCP SDU and a PDCP header (the PDCP header can be either 1 or 2 bytes long). FIG. 4 shows a flow diagram of the PDCP operations, transmitting and receiving. The transmitting PDCP entity assigns sequence numbers (SN) to upper layer PDUs (i.e., PDCP SDU) on a per-RB basis. Packets that are internally generated within the PDCP sub-layer, such as ROHC feedback packets, are not be assigned an SN.

The transmitting PDCP layer then performs ROHC header compression for user-plane traffic (ROHC-transmission control protocol (ROHC-TCP) and ROHC-RTP/UDP/IP will be supported). Integrity protection is then performed. For control-plane traffic, the SDU SN assigned by the PDCP sub-layer is utilized. Packets that are internally generated within the PDCP layer, such as ROHC feedback packets, will not be integrity-protected. Ciphering is then performed. The transmitting PDCP layer then attaches the PDCP header and sends the PDCP PDU to the RLC layer.

When a PDCP PDU is received, the receiving PDCP layer checks whether the PDU is control or data, and forwards it to the proper function, e.g., ROHC feedback packets are sent to the ROHC function. Deciphering is then performed utilizing the SDU SN assigned by the PDCP sub-layer along with the HFN, which is calculated using an “HFN delivery function” that can handle out-of-order reception

The receiving PDCP layer then checks for integrity for control-plane traffic. It should be noted that the integrity checking could be performed before or after deciphering. ROHC header decompression and duplicate detection, utilizing the SDU SN assigned by the PDCP layer, is then performed. The PDCP layer then performs reordering and delivers the PDCP SDUs in-sequence to upper layers.

During inter-eNB handover (HO) to a target eNB, a source eNB forwards all downlink PDCP SDUs with their SN that have not been acknowledged by the WTRU to the target eNB. The target eNB re-transmits and prioritizes all downlink PDCP SDUs forwarded by the source eNB. The source eNB then forwards uplink PDCP SDUs successfully received in-sequence to the system architecture evolution (SAE) Serving Gateway, and forwards uplink PDCP SDUs received out-of-sequence to the target eNB with their SN. The WTRU re-transmits the uplink PDCP SDUs that have not been successfully received by the source eNB. An example HO procedure is illustrated in FIGS. 6a and 5b, and shows various RRC signaling messages such as the HO Command and the HO Confirm.

The PDCP sub-layer then buffers the PDCP SDUs in order to be able to retransmit any un-received SDUs (e.g., during handover situations). In the uplink, the transmitting PDCP entity in the WTRU needs to retransmit the SDUs that were not acknowledged by the PDCP Status Report received from the Target eNB for example. In the downlink, the transmitting PDCP entity in the Source eNB forwards the SDUs that were not acknowledged to the Target eNB. The Target eNB retransmits the SDUs that were not acknowledged by the PDCP Status Report received from the WTRU for example. A PDCP status report is used to convey the information on missing or acknowledged PDCP SDUs (or PDUs) at handover. Status reports are sent from the receiving PDCP layer to the transmitting PDCP layer.

A PDCP mover receive window (MRW) message is used to convey the information on PDCP SDUs (or PDUs) that can not be retransmitted by the transmitting PDCP entity. MRW messages are sent from the transmitting PDCP entity to the receiving PDCP entity.

In Universal Mobile Telecommunications System (UMTS) releases, two PDCP-DATA primitives are allowed, namely, a PCDP-DATA-Req and PDCP-DATA-Ind. The PDCP-DATA-Req is used by upper user-plane protocol layers to request a transmission of an upper layer PDU. The PDCP-DATA-Ind is used to deliver to upper user plane protocol layers a PDCP SDU that has been received. The PDCP does not support any confirmation primitives.

Furthermore, the RLC sub-layer has its own transmit buffer (i.e., in the RLC transmitting entity). This means that there are at least two transmit buffers in Layer 2, one at the PDCP layer and the other at the RLC layer.

RLC SDU discard is included in one of the functions of the RLC functions disclosed above. The triggers to initiate SDU discard by the RLC include SDU discard timer expiration. An Acknowledged Mode (AM) RLC layer polls its peer AM RLC layer in order to trigger RLC STATUS reporting at the peer AM RLC layer. Triggers to initiate polling include the transmission of last data in the buffer.

Enhancing the interaction between layers in the protocol stack is needed for better reliability and performance. Therefore, a method and apparatus are needed to enhance the operation and interaction of layers in protocol stacks in the user and control planes.

### SUMMARY

A method and apparatus for enhancing certain packet data convergence protocol (PDCP) and Layer 2 operations is disclosed. A PDCP sends an indication of the successful or unsuccessful delivery of a data unit forwarded to it from an upper layer. The status indication from the PDCP may be in response to a direct request from the upper layer or sent automatically.

### BRIEF DESCRIPTION OF THE DRAWINGS

A more detailed understanding of the invention may be had from the following description, given by way of example and to be understood in conjunction with the accompanying drawing(s) wherein:

FIG. 1 shows an LTE user-plane protocol stack;

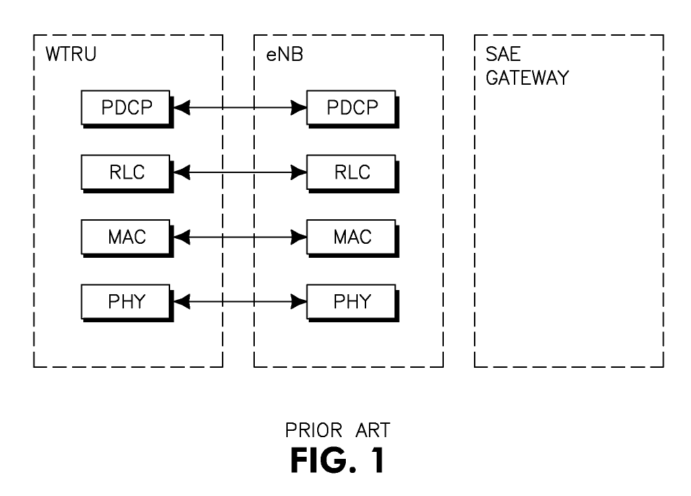

FIG. 2 shows a control-plane protocol stack;

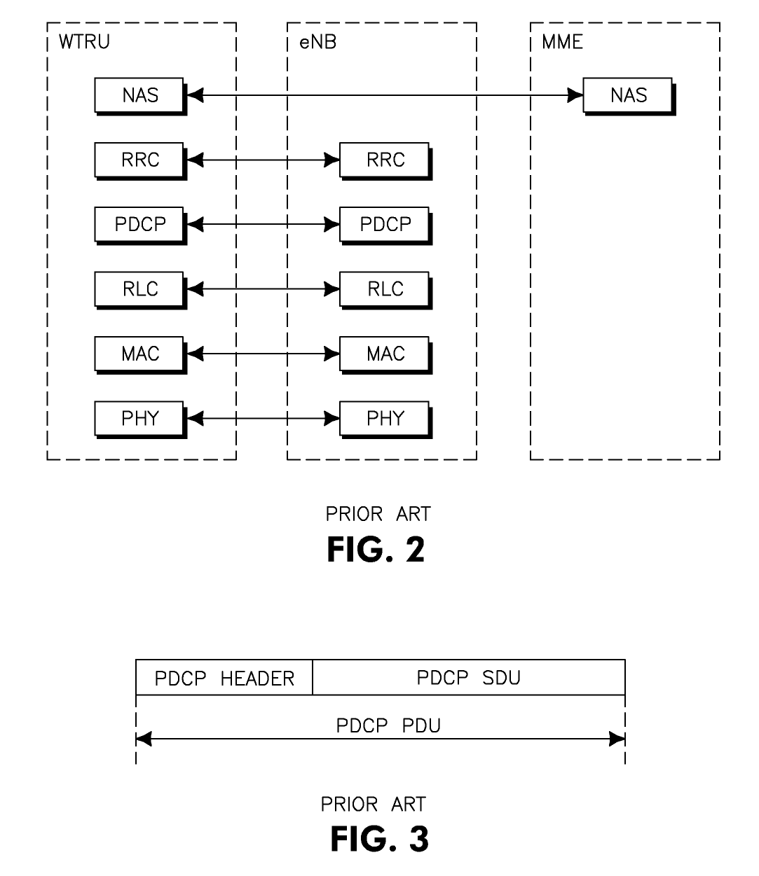

FIG. 3 shows a packet data convergence protocol (PDCP) packet data unit (PDU) structure;

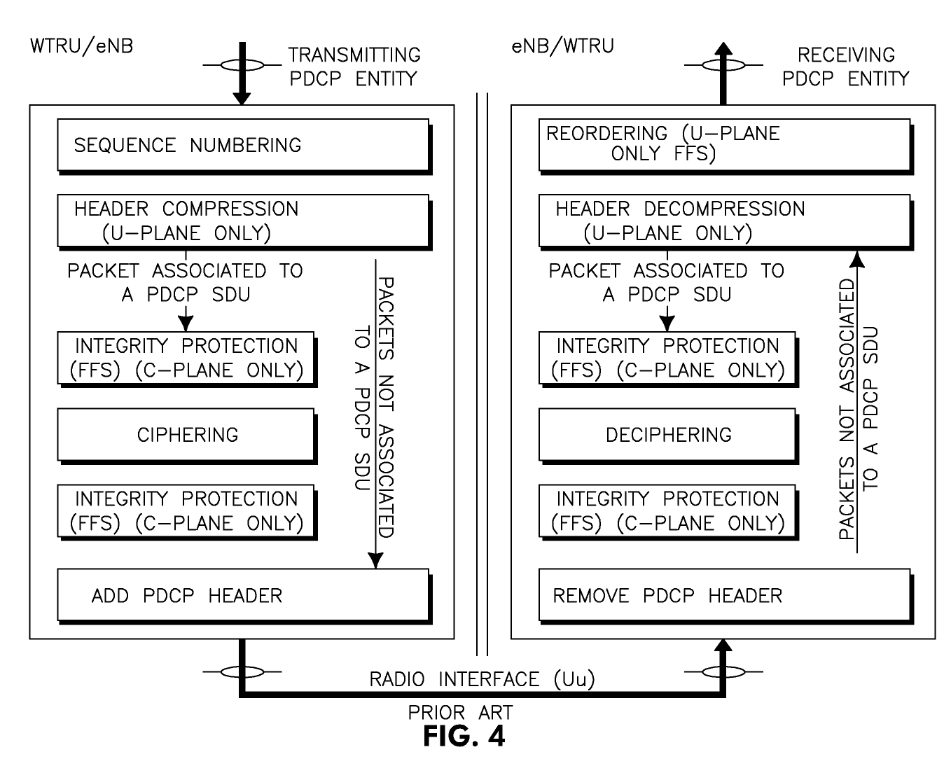

FIG. 4 shows a functional view of a PDCP sub-layer;

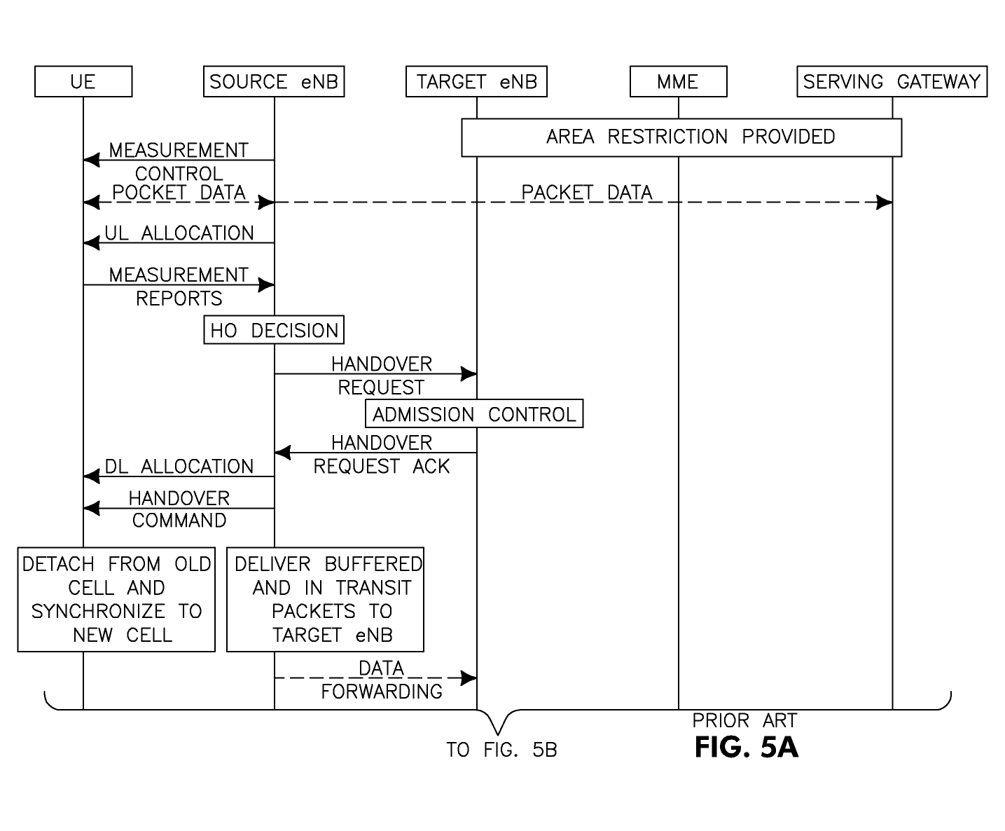

FIGS. 6a and 5b show an example handoff procedure;

FIG. 6 shows example transmitting and receiving entities configured to implement the disclosed method; and

FIG. 7 shows an example flow diagram of the disclosed method.

### DETAILED DESCRIPTION

When referred to hereafter, the terminology wireless transmit/receive unit (WTRU) includes but is not limited to a user equipment (UE), a mobile station, a fixed or mobile subscriber unit, a pager, a cellular telephone, a personal digital assistant (PDA), a computer, or any other type of device capable of operating in a wireless environment. When referred to hereafter, the terminology base station includes but is not limited to a Node-B, evolved Node-B (eNB), a site controller, an access point (AP), or any other type of interfacing device capable of operating in a wireless environment. A base station is a type of WTRU.

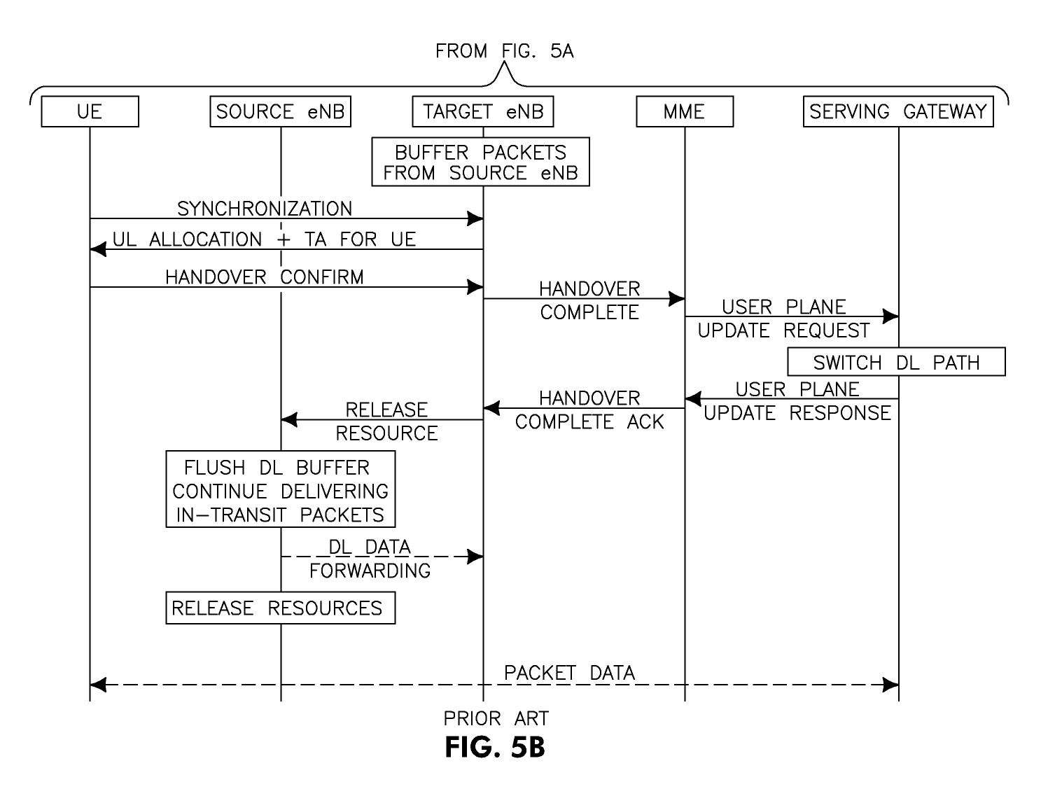

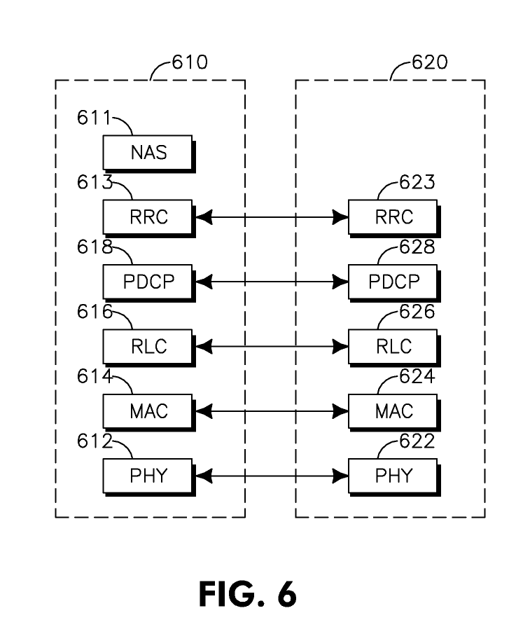

FIG. 6 shows an example user entity 610 (e.g., a WTRU) and a base station entity 620 (e.g., an eNB). The WTRU 610 and the eNB 620 comprise a physical layer 612, 622, a medium access control (MAC) layer 614, 624, a radio link control (RLC) layer 616, 626, a packet data convergence protocol (PDCP) layer 618, 628, and upper layers, respectively. The upper layers may include a network layer (e.g., Internet Protocol (IP)), a radio resource control (RRC) layer 613 and a non-access stratum (NAS) layer 611. Each layer of the control-plane and user-plane protocol stacks communicates information to the layer below, and the layer above, in the stack. It is to be noted that the terms “layer” and “sub-layer” are interchangeable. Also, the terms “PDCP” alone refers to any one of the following, a PDCP entity, the PDCP layer, PDCP sub-layer on PDCP functions/protocol. This is also the case for each of the respective terms MAC, RLC, RRC and NAS.

In accordance with a disclosed method and apparatus, in connection with WTRU transmissions, PDCP 618 forwards a delivery confirmation to the layers above, for example, RRC 613 in the control plane. As such, a primitive is used between PDCP and upper layer entities that is defined for confirming the delivery or discarding of information requested for delivery, e.g., a service data unit (SDU). An upper layer, such as RRC 613, may use the same signal used to request transmission of a PDCP SDU, for example, to indicate whether a Confirmation is required to be sent by PDCP 618 back to the upper layer. Accordingly, a new primitive is disclosed that is used by PDCP 618 to confirm, to the requesting upper layer, the delivery of an SDU, or to inform the requesting upper layer of a discarded SDU. It is to be noted that the term “primitive” includes, but is not limited to, a signal, an indication or a message. These terms, therefore, may be used with the term “primitive”.

In accordance with the above, a PDCP-DATA-Req primitive used by upper user-plane protocol layers to request a transmission of an upper layer PDU, includes a Confirmation Request (CNF) parameter that indicates whether the transmitting side of PDCP 618 needs to confirm the reception of the PDCP SDU. A Discard information Request (DiscardReq) parameter may also be included that indicates whether the transmitting side of the PDCP needs to inform the upper layers of a discarded PDCP SDU.

A PDCP-DATA-Conf signal can then be used by the PDCP 618 to confirm to upper layers the reception of a PDCP SDU by a peer PDCP 628, or to inform the upper layers of a discarded SDU. The PDCP-DATA-Conf signal may include the identity of the PDCP SDU, which is used to indicate which PDCP SDU is being confirmed or discarded, and the status of the PDCP SDU, i.e., whether confirmed or discarded.

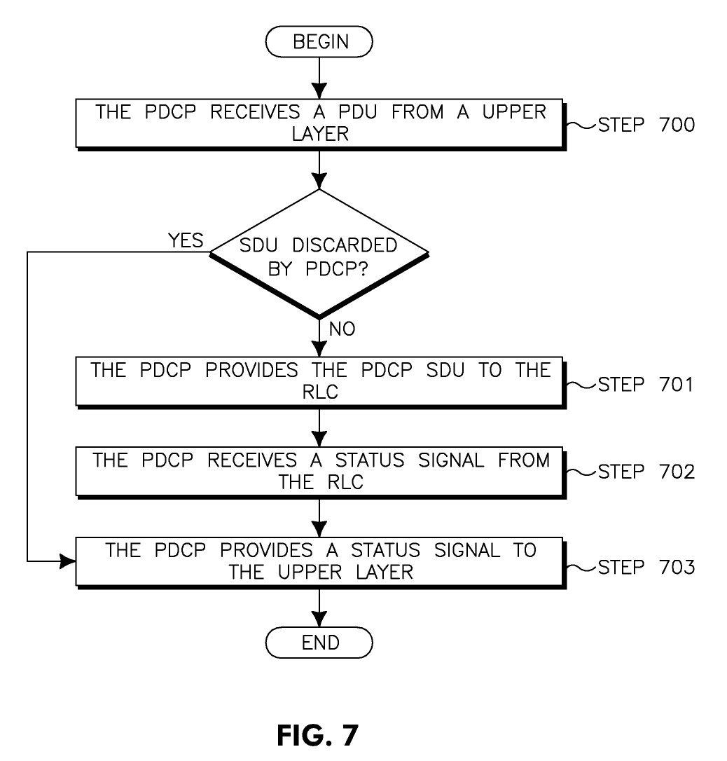

FIG. 7 shows an example flow diagram of the disclosed method for delivering a confirmation to a requesting upper layer by a PDCP 618. PDCP 618 receives a signal from RRC 613 requesting the delivery of a PDU to a receiving entity 620 (step 700). The PDU from RRC 613 may include an indication of whether a confirmation is required or not, which can be signaled by defining new parameters for primitives, such as defining a new parameter that is included in the PDCP primitive (e.g., PDCP-Data-Req), or for any other primitive used between PDCP and upper layers.

Upon receipt of the PDU, PDCP 618 determines if the PDU should be discarded. If the PDU is not discarded by PDCP 618, a PDCP SDU is provided to RLC 616 (step 701). PDCP 618 then determines whether the SDU was successfully delivered based at least in part on a delivery status signed from RLC 616 (step 702). The RLC signal from RLC 616 may indicate the successful delivery of the SDU, the discarding of the SDU by the RLC.

Upon receiving the delivery status signal from RLC 616, PDCP 618 submits a status signal to RRC 613 (step 703). For example, a positive status signal submitted to RRC 613 may represent the successful delivery of the SDU. A negative status signal may represent the discarding of the SDU by RLC 616 or by PDCP 618, or the failure to receive a successful delivery indication from RLC 616.

Upon receiving the confirmation, the upper layer (e.g., the RRC) reacts accordingly. For example, in the case of a negative status indication (e.g., a discard), RRC 613 may use such information to conduct retransmissions by various RRC procedures, and/or affect various RRC timer values. In the case of positive confirmation (e.g., confirming packet reception by the receiving side), RRC 613 may use such information to proceed faster to the next step(s) or phase(s) of its various RRC procedures, and/or to affect various RRC timer values.

In order to improve reliability for messages such as PDCP Status Reports, PDCP MRW, RRC messages, handover related signal, or any other signal, a new RLC Polling Trigger is disclosed whereby an RLC polling bit is set based on an indication (e.g., a primitive or a parameter in a primitive) from an upper layer(s). As such, it is disclosed that an upper layer, e.g., the PDCP layer 618, acts as a trigger to initiate RLC polling.

In accordance with this disclosed method, the transmitting PDCP 618 provides the submitted PDCP PDU (i.e., the RLC SDU) to the RLC entity 616, including an indication of whether a poll is required or not. Such an indication may be signaled using newly defined parameters for primitives, such as defining a new parameter for the RLC primitive RLC-AM-Data-Req (which is used by upper layers e.g., PDCP, to request the transmission of an RLC SDU), or for any other primitive that can be used between PDCP entity 618 and RLC entity 616.

Upon receiving an indication that a poll is requested, transmitting RLC 616 sets the polling bit in the header of the RLC PDU that includes, all or part of, the relevant SDU in order to trigger RLC STATUS reporting from peer RLC 626 (e.g., an AM RLC entity). As those having skill in the art know, RLC 626 may segment the RLC SDU into multiple PDUs. In this case, RLC 626 sets the polling bit in the header of the RLC PDU that includes the last segment of the RLC SDU. Alternatively, the polling bit may be included in the header of the RLC PDU that includes the first segment of the RLC SDU, any RLC PDU that includes a segment of the RLC SDU; or all RLC PDUs that include a segment of the RLC SDU.

Once the RLC STATUS report is received, transmitting RLC 616 may retransmit the missing packet if loss occurs, thereby increasing the reliability of transmission for PDCP Status Reports or other control information submitted by higher layers, since those reported as received.

In an alternative, rather than explicitly requesting polling, the primitive parameter may identify control information (e.g., PDCP Control PDUs) submitted by transmitting PDCP 618 to transmitting RLC entity 616. Transmitting RLC entity 616 then initiates RLC polling for those control packets received from upper layers.

As indicated, the polling request may come from any upper layer other than PDCP 618. Therefore, the polling indication or control indication may be signaled from an upper layer (e.g., RRC 713) to PDCP 718, which then delivers the indication to RLC 716. For example, the primitive PDCP-Data-Req can be enhanced to support a Polling indication or a Control-traffic indication. Hence, an upper layer (e.g., RRC) that uses the primitive PDCP-Data-Req can specify whether polling is required or the type of information. PDCP 618 then communicates this to RLC 616 via the primitive RLC-AM-Data-Req, for example, which initiates the polling mechanism by RLC 616.

As described in the Background section above, the PDCP MRW procedure is used by transmitting PDCP 618 to notify receiving PDCP 628 to move receiving PDCP entity's 628 receive window when certain packets are no longer available in the PDCP transmit buffer, for example.

A method is disclosed, wherein the generation of the PDCP MRW message is triggered by one or more of an RLC reset or re-establishment; an handover event; or a signal (e.g., a new primitive or parameter) from RRC 616 to PDCP 718.

In accordance with this method, in a WTRU or eNB, if transmitting RLC 616 or RRC 613 signals that the RLC is reset or re-established, or that a handover event occurred, or a primitive requesting the generation of a PDCP MRW message is provided to transmitting PDCP 618, transmitting PDCP 618 generates the PDCP MRW and sends it to peer PDCP entity 628.

As with PDCP MRW messages, a method is disclosed where a trigger for generating a PDCP status report message may be signaled from RRC 613 to PDCP 618 (e.g., a new primitive or parameter). At a receiving node (e.g., the WTRU or eNB), a receiving RRC 623 (e.g., RRC entity) may signal a primitive to receiving PDCP 623 requesting PDCP Status Report generation upon receipt of this primitive, receiving PDCP entity 628 generates the PDCP Status Report and sends it to peer PDCP 618. An example primitive may be called CPDCP-Status-Req, which again, can be used by RRC 613 to trigger PDCP 618 in the same node to generate a PDCP Status Report.

In order to enhance the reliability and timeliness of PDCP Status Reports, the PDCP Status Reports may be included in handover (HO) messages, such as the HO Command and the HO Confirm. The PDCP status reports may also be included with any other RRC messages.

In accordance with a disclosed method, RRC 616 utilizes existing primitives such as PDCP-DATA-Req, or the like, to request generation of a PDCP status report. As an example, the primitive PDCP-DATA-Req requests transmission of a PDU by PDCP 618, such as requesting the transmission of RRC PDUs that include a HO Command, HO Confirm, or any other RRC message. Currently a PDCP-DATA-Req only has one parameter associated with this primitive, which is the Data whose transmission is requested. In this disclosed method, the PDCP-DATA-Req includes an additional parameter that indicates whether or not the generation and transmission of a PDCP Status Report is needed. Such an additional PDCP-DATA-Req parameter may be referred to as a StatusReportRequest. Additional parameters or information may also be included, such as the Radio Bearer (RB) identity (or identities) for which a Status Report(s) is to be generated/transmitted.

In an alternative method, RRC 613 uses a new primitive to request the PDCP status report (e.g., CPDCP-Status-Req). As an example, in a WTRU, RRC 613 generates an RRC message, such as a HO Confirm message. As stated above, RRC 613 uses the PDCP-DATA-Req primitive to request the transmission of a message (e.g., the HO Confirm message) and includes the request that a PDCP Status Report be generated via setting the primitive's parameter which indicates to PDCP 618 to generate the report. In this alternative, the RRC entity 713 sends a separate primitive, not associated with the data transmission, such as the CPDCP-Status-Req, to indicate to PDCP 618 to generate the report.

PDCP 618, therefore, generates the PDCP Status Report(s) for any RB where PDCP Status Reports are configured, or for the RB identities specified in the primitive (if the primitive can specify RB identities).

Another trigger for generating a PDCP Status Report may be used. As the receiving PDCP entity 728 will need to perform reordering (in-sequence delivery) for some RB's, if the PDCP reordering function detects SN gaps (e.g., missing SN's) then that could be used as a trigger for generating a PDCP Status Report by receiving PDCP 628. This could also be combined with a timer mechanism. For example, the PDCP Status Report will be generated after X time units from detecting a missing SN (SN gap). Such a trigger can further enhance the reliability by providing faster PDCP retransmissions.

The PDCP Status Reports may be sent on the same RB as the RRC message (i.e., on a Signaling RB (SRB)). This allows RLC 616 to concatenate the RLC SDU that includes the RRC message (e.g., HO Confirm message) with the RLC SDU(s) that include the PDCP Status Report(s).

Included in the PDCP Status Report (or PDCP Control PDUs in general), a RB Identity may be specified for which the Status Report corresponds (i.e., the RB to which the acknowledgement information included in the Status Report pertains).

Alternatively, the PDCP Status Reports can be sent on the same (user-plane) RB for which the Status Report information corresponds (i.e., NOT on a Signaling RB). Since the Status Report is sent on the same RB to which the Status Report's acknowledgement information pertains, the Status Report does not need to specify the RB ID as part of its contents.

The MAC multiplexing scheme performs “ordered” multiplexing whereby it prioritizes the PDUs received from the control logical channels (or SRBs) over those from the data logical channels (or RB's). By doing so, the additional benefit from having the MAC multiplex the MAC SDU that includes the RRC message (e.g., HO Confirm message) with the MAC SDU(s) that contain the PDCP Status Report(s) is realized.

If PDCP Status Reports are to be sent on their own ‘associated’ RB in a timely fashion, then PDCP 618 may submit a PDCP PDU to a lower layer, allowing PDCP 618 to prioritize the transmission of the PDCP Control PDUs (including the Status Reports) over the transmission of PDCP Data PDUs. Accordingly, the PDCP Status Reports will be transmitted first, which will assist in ensuring that when the WTRU moves to a target eNB for example, and a WTRU is granted a transmission opportunity, then the PDCP Status Reports are sent at the start of the corresponding RB transmissions in the target eNB.

In another alternative, once a PDCP Status Report is generated, instead of submitting it directly from PDCP 618 down to RLC 616, the PDCP Status Report(s) are sent first to RRC entity 613 using a new primitive, such as CPDCP-StatusReport-Ind. RRC 613, then sends the PDCP Status Report via a Signaling RB (SRB) back to PDCP 618, and PDCP 618, in turn, sends it down to RLC 616. As such, the PDCP Status Report flows within the same node as follows: from PDCP 618 to RRC 613 to PDCP 518 to RLC 616 to transmission.

The methods disclosed above are applicable to other scenarios which were not described in the given examples. For example, an eNB (as opposed to the WTRU) can make use of the methods when sending a PDCP Status Report along with an RRC message. These same disclosed methods for sending PDCP Status Reports can also be applied for sending PDCP MRW messages.

The PDCP 618, in a disclosed method, may transmit multiple copies of the PDCP Status Report. For example, instead of transmitting only once, a second transmission of the PDCP Status Report is initiated at a later time.

Alternatively, the PDCP 618 may conduct retransmissions of PDCP Status Reports based on delivery or lack thereof, of notifications or confirmations by lower layers, such as the RLC 616 and/or hybrid automatic repeat request (HARQ), or based on discard information conveyed by lower layers.

Where the PDCP 618 receives multiple Status Reports with respect to WTRU transmissions, for example, indicating multiple negative acknowledgements for a given packet, if the PDCP 618 still has the PDCP packet (SDU) stored in its PDCP buffer, the PDCP 618 can retransmit the SDU for an unlimited number of times, i.e., every time it is indicated as not received by a PDCP 628, or the transmitting PDCP 618 can retransmit the SDU for a limited number of times, e.g., only once or Z number of times.

If the PDCP 618 still has the PDCP packet (SDU) stored in its PDCP buffer, but the allowed number of PDCP retransmissions is reached, the transmitting PDCP 618 can not retransmit the SDU since the SDU will be discarded upon reaching the allowed (maximum) number of retransmissions. The PDCP 618 may then explicitly notify the peer PDCP 628 by transmitting a PDCP MRW message, for example.

If the PDCP entity 618 does not have the PDCP packet (SDU) stored in its PDCP buffer, the PDCP entity 618 cannot retransmit the SDU, and therefore, may explicitly notify the peer PDCP entity 628 by sending it a PDCP MRW message for example.

Also, another trigger for discarding a PDCP SDU may be discarding a PDCP SDU upon reaching a maximum (allowed) number of PDCP transmissions or retransmissions.

A method for re-transmission of PDCP SDUs, preferably in uplink communications, is disclosed. To determine which is a PDCP SDU to retransmit, the WTRU waits until it receives the PDCP Status Report from the eNB. For example in HO, the target eNB sends the Status Report. When the transmitting PDCP entity in the WTRU receives the report, the WTRU analyzes the report and starts transmission by retransmitting PDCP SDUs that were negatively acknowledged (i.e., were not received) by the target eNB. Retransmission may be done in an ordered fashion, where SDUs with the lower SN's are transmitted before those with higher SN's.

In an alternative, the PDCP Status Report is not provided. For example, there may or may not be an interface for both the control and user planes between source and target eNBs (i.e. an X2 interface). If there is no X2 interface between the source and target eNBs, then it may not be possible to forward PDCP SDUs between eNBs, and therefore, the target eNB may not be able to construct a proper PDCP Status Report.

Accordingly, an indication may be added to the HO Command (or to an RRC message in general), whereby the eNB can indicate to the WTRU whether or not an X2 interface is available between the Source eNB and the Target eNB. The indication included in the HO Command may also indicate whether or not forwarding of SDUs between Source and Target eNBs is supported, or whether or not communicating PDCP Status information between Source and Target eNBs is supported, etc.).

As another alternative, an indication may be added to the HO Command, whereby the eNB indicates to the WTRU whether or not a PDCP Status Report will be sent to the WTRU (e.g., by the Target eNB), or what SDU retransmission behavior the WTRU should utilize. If the WTRU is notified that it will not be receiving a PDCP Status Report (e.g., based on the above), or if the WTRU waits but simply does not receive a Status Report (after waiting an expected time, or an event occurs such as the reception of a certain RRC message without the reception of a Status Report), then the WTRU may determine on its own, utilizing the latest RLC status and/or HARQ status, for example, which PDCP SDUs need to be retransmitted.

The WTRU performs either selective retransmissions for those un-received SDUs, or conducts cumulative retransmissions starting from the first un-received SDU. Alternatively, the WTRU retransmits everything stored in its PDCP SDU buffer.

Retransmission may be done in an ordered fashion, where SDUs with the lower SN's are transmitted before those with higher SN's.

As an alternative when no status report is provided to the WTRU, the Source eNB may provide a PDCP Status Report to the WTRU. The Source eNB sends the WTRU a PDCP Status Report (e.g., along with the HO Command) always or alternatively, when the Source eNB knows that it not possible for the Target eNB to send an accurate (up to date) PDCP Status Report e.g., when there is no X2 interface.

Once the Source eNB sends the Status Report, and when the transmitting PDCP entity in the WTRU receives it, the Report is analyzed and the PDCP SDUs that were negatively acknowledged (i.e., were not received) in the Source eNB's PDCP Status Report to the Target eNB. Retransmission may be done in an ordered fashion, where SDUs with the lower SN's are transmitted before those with higher SN's.

In another disclosed method, the WTRU may start uplink transmission to a Target eNB before it receives the PDCP Status Report from the Target eNB.

The WTRU may then utilize the PDCP Status Report transmitted in the Source eNB (e.g., along with the HO Command for example), and/or the latest RLC status or HARQ status (e.g., RLC delivery confirmations) information in the WTRU.

Accordingly, the WTRU performs selective retransmissions of SDUs based on this information. The WTRU can also perform cumulative retransmission or can retransmit everything stored in its PDCP SDU buffer.

Once the WTRU receives the Target eNB's Status Report, the WTRU may refine its retransmission behavior by performing selective retransmissions for packets (SDUs) specified as un-received by the Target eNB's Status Report, and that were not already transmitted in the previous retransmission phase.

In another disclosed method, if there is no X2 interface between Source and Target eNB, and the uplink SDUs cannot be forwarded from Source eNB to Target eNB, in order to not negatively affect the PDCP reordering behavior performed by the Target eNB in uplink, PDCP 618 of WTRU 610 may utilize selective retransmission of SDUs together with the PDCP MRW procedure to move the PDCP data reception window. This allows the reordering operation to be optimized while minimizing duplicate PDCP transmissions. In an example, the transmitting PDCP may rely on a PDCP Status Report transmitted by the Source eNB, or on RLC status information. Selective retransmission for un-received (missing) PDCP SDUs is then performed. For SDUs that were indicated as received (e.g., by PDCP Status Report transmitted by the Source eNB or by RLC status information), the WTRU utilizes the PDCP MRW procedure to move the window of the Target eNB and to optimize reordering operations at the target eNB.

Another example of a disclosed method includes a source eNB providing a PDCP Status Report to the WTRU (e.g., along with HO Command). Once the WTRU moves to the target eNB, the WTRU performs selective retransmissions of uplink SDUs based on the information conveyed in the Source eNB's PDCP Status Report.

Upon receiving the target eNB's PDCP Status Report, the WTRU optimizes its uplink retransmissions based on the information conveyed in the Target eNB's PDCP Status Report. The WTRU will then only retransmit SDUs one time based on either the Source eNB's or Target eNB's Status Reports (i.e., it will not retransmit the same SDU twice, one for each report).

Although the above is described for uplink, similar methods may be applied for downlink transmissions. A preferred WTRU is configured with a hierarchy of processing layers including RLC, PDCP and RRC layers configured to implement one or more of the methods described above and/or complementary report functions for reception of downlink data. A preferred base station or eNB is configured with a hierarchy of processing layers including RLC, PDCP and RRC layers configured to implement one or more of the methods described above either as a source or target node and/or complementary report functions for downlink transmissions.

The above methods are applicable even if there are future changes or modifications to the PDCP or layer 2 functionality. For example, the above still applies if sequence numbering is done on a per PDCP PDU level instead of PDCP SDU level.

Although the features and elements are described in particular combinations, each feature or element can be used alone without the other features and elements or in various combinations with or without other features and elements.

The methods or flow charts provided may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for selectively indicating a transmission status of data packets within a multi-layer protocol stack of a wireless communication apparatus:
providing a data packet from an upper layer for transmission to a data packet convergence protocol (PDCP) layer;
determining in the PDCP layer the status of the transmission of the data packet; and
providing to the upper layer a status signal based on the determination.

2. The method of claim 1, further comprising:
submitting the packet to a radio link control protocol (RLC) layer for controlling the transmission of the packet to a receiving entity.

3. The method of claim 2, further comprising:
receiving an indication from the RLC layer regarding the status of the delivery of the packet.

4. The method of claim 3, wherein the PDCP layer determines the status of the packet based at least in part on the RLC layer indication.

5. The method of claim 4, wherein the RLC layer indication is positive if the packet has been successfully delivered to the receiving entity.

6. The method of claim 5, wherein a positive status signal is provided to the upper layer by the PDCP layer.

7. The method of claim 3, further comprising:
the PDCP layer discarding the packet.

8. The method of claim 7, wherein a negative status signal is provided to the upper layer by the PDCP layer.

9. The method of claim 1, further comprising providing a primitive to the PDCP layer from the upper layer, the primitive including a request for the status signal from the PDCP layer.

10. The method of claim 9, wherein the primitive is included in the data packet.

11. The method of claim 1, wherein the upper layer is a radio resource control (RRC) layer.

12. A wireless transmit receive unit (WTRU) comprising:
a hierarchy of processing layers configured to implement a protocol stack for selectively transmitting and receiving data;
the protocol stack including:
an upper layer; and
a packet data convergence protocol (PDCP) layer configured to receive data packets from the upper layer for transmission via lower layers, to subsequently determine the status of the packets and to provide the upper layer a status signal based on the determination.

13. The WTRU of claim 12 wherein the protocol stack further includes a radio link control (RCL) layer configured to receive the packets from the PDCP layer and to control the transmission of the packets to a receiving entity.

14. The WTRU of claim 12 wherein the PDCP layer is configured to receive a primitive from the upper layer, the primitive including a request to receive the status signal from the PDCP.

15. The WTRU of claim 14 wherein the primitive is included in the data packets.

16. The WTRU of claim 13 wherein the PDCP layer is configured to determine the status of data packets using an indication from the RLC layer regarding the status of the delivery of the packet.

17. The WTRU of claim 16 wherein the RLC layer is configured to provide a positive indication if a data packet has been successfully delivered.

18. The WTRU of claim 16 wherein the status signal is negative when delivery of the packet by the RLC has failed.

19. The WTRU of claim 13, wherein the PDCP layer is configured to selectively discard data packets received from the upper layer and to determine the status of a data packet as negative when the PDCP discards the packet prior.

20. The WTRU of claim 12 configured as a User Equipment for a third generation partnership project (3GPP) long term evolution (LTE) system.
